(19) United States
(12) Patent Application Publication
(10) Pub. No.: US 2024/0356820 A1
(43) Pub. Date: Oct. 24, 2024

(54) METHODS, SYSTEMS, ARTICLES OF MANUFACTURE AND APPARATUS TO VERIFY INTEGRITY OF MODEL EXECUTION ON COMPUTING RESOURCES USING TELEMETRY INFORMATION

(71) Applicant: Intel Corporation, Santa Clara, CA (US)

(72) Inventors: Abhishek Chakraborty, Hillsboro, OR (US); Chen Liu, Portland, OR (US); Jason Mou Lap Fung, Portland, OR (US)

(21) Appl. No.: 18/753,830

(22) Filed: Jun. 25, 2024

(51) Int. Cl. H04L 41/5009; H04L 43/08

(52) U.S. Cl. CPC H04L 41/5009; H04L 43/08

(57) ABSTRACT

Systems, apparatus, articles of manufacture, and methods are disclosed to verify integrity of model execution on computing resources using telemetry information. An example apparatus includes machine-readable instructions, and at least one processor circuit to be programmed by the machine-readable instructions to instruct one or more first computing resources of a service provider to process a first model, compare first telemetry performance metrics received from the service provider with second telemetry performance metrics associated with baseline computing resources, and verify an integrity score of the service provider based on a similarity metric associated with the first telemetry performance metrics and the second telemetry performance metrics.

### BACKGROUND

In recent years, cloud service providers (CSPs) have become a resource for workload computation that reduces capital investment requirements for workload designers. Such workload designers provide one or more tasks to the CSP for execution in exchange for a fee.

### BRIEF DESCRIPTION OF THE DRAWINGS

FIG. 1 is a block diagram of an example environment in which example target resource verification circuitry operates to verify an integrity of model execution on computing resources using telemetry information.

FIG. 2 is a block diagram of an example implementation of the target resource verification circuitry of FIG. 1.

FIGS. 3-6 are flowcharts representative of example machine-readable instructions and/or example operations that may be executed, instantiated, and/or performed by example programmable circuitry to implement the target resource verification circuitry of FIG. 2.

FIG. 7 is a block diagram of an example processing platform including programmable circuitry structured to execute, instantiate, and/or perform the example machine-readable instructions and/or perform the example operations of FIGS. 3-6 to implement the target resource verification circuitry of FIG. 2.

FIG. 8 is a block diagram of an example implementation of the programmable circuitry of FIG. 7.

FIG. 9 is a block diagram of another example implementation of the programmable circuitry of FIG. 7.

FIG. 10 is a block diagram of an example software/firmware/instructions distribution platform (e.g., one or more servers) to distribute software, instructions, and/or firmware (e.g., corresponding to the example machine-readable instructions of FIGS. 3-6) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

Deep neural networks (DNNs) and/or other large language models (LLMs) are computationally intensive processes. In some scenarios, computationally intensive processes (e.g., model inference tasks) of any type (e.g., other types of models, deep learning (DL) models, machine learning as a service (MLaaS), other types of neural networks (NNs), etc.) rely on particular computational resources and/or a quantity of such computational resources that is associated with a substantial capital investment. In view of these computational burdens and cost, inference tasks are outsourced by a model owner (e.g., a client, an end user) to third party cloud service providers (CSPs). In some scenarios, the CSP (sometimes referred to herein as a service provider) completes workload tasks based on one or more fee structures, such as computational costs on a per task basis, a per thermal unit basis, a per computing cycle basis, etc.

Both the end user and the CSP have a degree of exposure or risk in inference tasks (e.g., workload task execution). From the point of view of the CSP, payment is expected in response to completion of one or more inference tasks that consume one or more computing resources. Inference task completion is typically evidenced by one or more data structures of result(s) information transmitted by the CSP to the end user after a client-supplied data (e.g., one or more specific datasets) has been subjected to a specific model during inference. Despite a good faith inference task completion by the CSP, a malicious end user could repudiate payment after receiving inference results. From the point of view of the end user, a malicious CSP could replace the model sent by the end user (e.g., a DL model) with a simpler or compressed model, thereby reducing a computational burden on the CSP during inference. However, end users expect that particular models to be executed on particular client-supplied data are used during inference tasks, rather than substitute models that may allow the CSP to save resources and/or cost. As such, end users have no assurances that the specified and/or otherwise proper model was used by the CSP when performing one or more inference tasks.

Examples disclosed herein facilitate techniques to reduce risk and/or concern by the CSP and the end user when engaging in inference task performance. In particular, examples disclosed herein cause the CSP to provide inference task outcomes (e.g., data structure(s) of results) only after payment is received from the end user. However, prior to an end user authorizing payment for one or more inference tasks, examples disclosed herein enable the end user to verify an integrity (e.g., an integrity score, a measurement of correctness) of the inference task(s) performed by the CSP based on a similarity metric between one or more telemetry profiles of an end user computing resource and one or more telemetry profiles of a CSP computing resource.

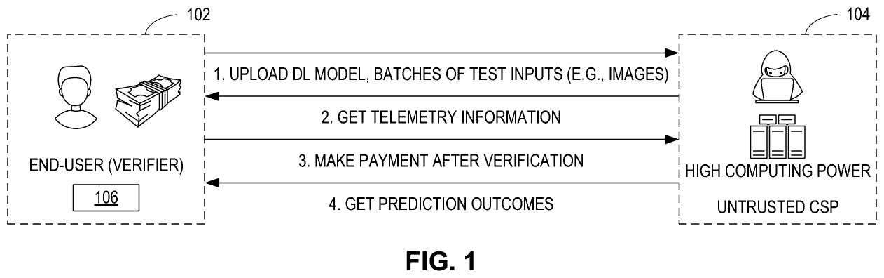

FIG. 1 is a block diagram of an example environment 100 to verify an integrity of model execution on computing resources using telemetry information. In the illustrated example of FIG. 1, the environment 100 includes an end user platform 102, such as a network-accessible computing device (e.g., a personal computer (PC), a server, a tablet, etc. The end user platform 102 includes one or more computing resources, sometimes referred to herein as baseline computing resources. The example environment 100 also includes a CSP 104, which may include any number of general-purpose or specialized computing devices capable of performing inference tasks on workloads (e.g., one or more batches of data, input data sample(s), batches of input data sample(s), etc.). The example end user platform 102 is communicatively connected to the example CSP 104. The example end user platform 102 includes example target resource verification circuitry 106 to verify the integrity of model execution on computing resources using telemetry information.

In operation, and as described in further detail below, the target resource verification circuitry 106 uploads a quantity of input data, such as a model and one or more batches of data to the CSP 104. In particular, the upload includes instructions that direct the CSP to perform inference tasks in a manner that uses a specific model (e.g., a particular DL model, such as Resnet18, ConvNet, etc.) with specific data (e.g., a CIFAR-10 dataset including arrays of images (e.g., color images). As described in further detail below, the upload also includes instructions to cause the CSP 104 to generate telemetry information (e.g., telemetry performance metrics, energy metrics, etc.) based on the inference tasks, in which the telemetry information is based on a particular granularity parameter.

After the CSP 104 performs one or more inference tasks using the specified model (e.g., Resnet18) and specified data, the end user platform 102 receives, retrieves and/or otherwise obtains the telemetry information from the CSP 104. As used herein, telemetry information includes operating metrics of the CSP 104 when performing the inference tasks with a model and particular data on which the model will operate. In some examples, telemetry information includes power values, voltage values, and/or thermal values. The telemetry information may correspond to particular portions of workload data, such as a particular energy metric value (e.g., watts, temperature, computing cycles consumed, etc.) associated with processing a particular input data sample (e.g., element i and element j). In some examples, the granularity parameter(s) cause the CSP 104 to measure and/or otherwise report the telemetry information for a specific computing resource (e.g., a particular processor core) and/or report the telemetry information for a specific layer of the specified model performing the inference task(s). In some examples, the granularity parameters include layer assignment parameters to cause the computing resources to calculate performance metrics associated with particular layers of a selected model (e.g., particular layers of a ConvNet model).

Upon receipt of the telemetry information reported by the CSP, the end user platform 102 analyzes the telemetry information to verify that the CSP 104 has performed the one or more inference tasks in a manner consistent with the specified model and the specified data. In particular, the verification performed by the end user platform 102 includes a comparison of the telemetry information reported by the CSP to baseline telemetry information performed by computing resources of the end user platform 102. In some examples, the computing resources of the end user platform 102 perform inference on a subset of the specified data that was sent to the CSP 104, in which the subset of the specified data includes a proportional quantity of data that is processed by the CSP 104 during inference. As such, one or more values of the telemetry information reported by the CSP 104 may be factored-down in a proportional manner when comparing one or more values of the telemetry information reported by the end user platform 102.

If the target resource verification circuitry 106 of the end user platform 102 determines that the telemetry information obtained from the CSP 104 is accurate and/or otherwise trustworthy, then the end user platform 102 causes payment authorization for the inference task(s) performed by the CSP 104. Additionally, after receiving payment, the CSP 104 releases and/or otherwise transmits prediction output to the end user platform 102.

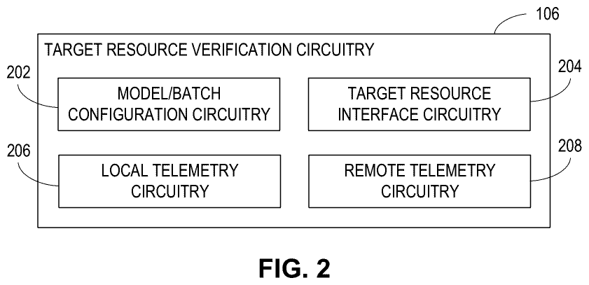

FIG. 2 is a block diagram of an example implementation of the example target resource verification circuitry 106 of FIG. 1 to verify the integrity of model execution on computing resources using telemetry information. The target resource verification circuitry 106 of FIG. 2 may be instantiated (e.g., creating an instance of, bring into being for any length of time, materialize, implement, etc.) by programmable circuitry such as a Central Processor Unit (CPU) executing first instructions. Additionally or alternatively, the target resource verification circuitry 106 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

In the illustrated example of FIG. 2, the target resource verification circuitry 106 includes example model/batch configuration circuitry 202, example target resource interface circuitry 204, example local telemetry circuitry 206, and example remote telemetry circuitry 208.

In operation, the example model/batch configuration circuitry 202 selects model and test batches to be used for verification of the integrity of model execution by the CSP 104. The example model-batch configuration circuitry 202 selects and/or otherwise configures a telemetry granularity parameter and a number of local inference iterations to be used for verification operations. The example target resource interface circuitry 204 transmits instructions to obtain (e.g., collect, retrieve, receive) telemetry information, model, and test batches (e.g., workload(s)) to target computing resources (e.g., the CSP 104). These instructions cause the CSP 104 to begin inference tasks using the selected model and the test batches, the output of which will include two parts. A first part of the output includes telemetry information associated with the inference tasks. In some examples, the telemetry information includes power metrics measured by the CSP 104 when performing inference of the test batches while using the selected model. While examples disclosed herein describe power metrics, examples disclosed herein are not limited thereto. A second part of the output includes results of the inference tasks, but the results information is withheld, hidden, and/or otherwise refrained from being sent back to the target resource verification circuitry 106 until after the CSP 104 receives payment for efforts related to a valid inference task(s).

The example local telemetry circuitry 206 determines local telemetry vectors, and the target resource interface circuitry 204 retrieves the remote telemetry data from the CSP 104 (e.g., or target hardware resources). The example remote telemetry circuitry 208 determines one or more remote telemetry vectors based on the received remote telemetry data, which includes telemetry data samples (e.g., power values) and associated sample index values (e.g., sample i, sample j, sample k, etc.). The example target resource verification circuitry 106 determines a verification status related to the integrity of computations performed by the CSP 104 based on a comparison of the one or more telemetry vectors of the end user 102 and the CSP 104, and either releases payment for the inference tasks or denies payment for the inference tasks based on the verification status, as described in further detail below.

As described above, the example local telemetry circuitry 206 determines one or more local telemetry vectors. In some examples, a telemetry vector is a data structure having an energy metric (e.g., power, voltage, heat unit, etc.) and a sample index value. For instance, the specific data samples to be used for verification of model execution integrity may include one or more values to be processed as an element having an element index (e.g., index i, index j, index k, etc.). For example, element index i may include a current value (e.g., 100 mA) and a resistance value (e.g., 2 kOhms) so that the model can apply a voltage calculation to that element to derive a voltage value (e.g., V=IR). At least one observation facilitated by examples disclosed herein is that relative variations in particular telemetry readings (e.g., power consumption data) collected during model inference phase execution are correlated with a structure of a neural network and the test batches. Observed correlations are observed to be consistent across different underlying hardware platforms (e.g., end-user computing platform(s) and CSP systems).

In some examples, given a DNN architecture and one or more chosen sets of input batches (e.g., S1 and S2), then corresponding power consumption magnitudes due to execution of DNN inference task(s) is (i) P1 and P2 in an end-user system and (ii) P1′ and P2′ in a CSP system. In the event P1 is greater than P2, then P1′ should also be greater than P2′, and vice-versa. Stated differently, if the resulting power value determined on computational resources of the end user platform 102 are proportionally similar to the resulting power value determined on computational resources of the CSP 104 (e.g., within an acceptable error factor E), then the CSP 104 is determined to be behaving in a manner consistent with end-user expectations (e.g., using the properly selected model and corresponding test data samples).

To determine the local telemetry vector(s), the example local telemetry circuitry 206 acquires pairs of telemetry data samples corresponding to the workload(s). In some examples, the local telemetry circuitry 206 randomly selects N pairs of elements {T_{local}ⁱ, T_{local}^{j}}, where i and j (i≠j) are indices of selected elements. The local telemetry circuitry 206 generates a list of local ratios corresponding to the selected pairs to generate a list of tuples in a manner consistent with example Equation 1.

$$Tuples ( local ) = \{ ( \frac{{T}_{local}^{i}}{{T}_{local}^{j}} ) , i , j \} . \qquad Equation 1$$

In some examples, the local telemetry circuitry 206 sorts a list of tuples with respect to the first element of the tuple. In the illustrated example of Equation 1, and assuming that the telemetry metric of interest relates to power (e.g., watts, mW, etc.), the ratio T_{local}ⁱ/T_{local}^{j} is an indication of how much power was consumed by local computing resources on the data associated with element i divided by the amount of power consumed by local computing resources on the data associated with element j. In some examples, energy and/or power telemetry readings are obtained from on-chip sensors present in the computing resource(s). In this context, data associated with element i and element j are such on-chip sensor readings based on processing of corresponding test batches during the inference task. The list of such tuples is generated by the local telemetry circuitry 206 as a local telemetry ratio vector TR_{local}.

To determine a remote telemetry ratio vector TRᵣₑₘₒₜₑ that corresponds to power consumed by the CSP 104, the example remote telemetry circuitry 208 generates a list of remote ratios that correspond to indexed elements of the local sorted list. For example, as described above element i is associated with a relatively straightforward and/or otherwise simple multiplication operation performed by the end user platform 102, which results in a finite amount of consumed power (T_{local}ⁱ). Element i and element j are associated with a same set of operations as present in the inference phase of the AI/ML model of interest, but operate using different test batches. In operation, the CSP 104 executes all test batches for an inference task, however the end-user only executes a selective subset of test batches for the purpose of verification. Examples disclosed herein permit the end-user a manner of telemetry profile comparison for a “local run” in the end-user system, and a “remote run” in the CSP 104 system for the same subset of batches. In this circumstance, the CSP 104 is unaware of which subset of test batches are selected by the end-user for purposes of verification. The example remote telemetry circuitry 208 generates a list of remote ratios corresponding to the selected pairs to generate a list of tuples in a manner consistent with example Equation 2.

$$Tuples ( remote ) = \{ ( \frac{{T}_{remote}^{i}}{{T}_{remote}^{j}} ) , i , j \} . \qquad Equation 2$$

In the illustrated example of Equation 2, under the same assumption that the telemetry metric of interest relates to power (e.g., watts, mW, etc.), the ratio Tᵣₑₘₒₜₑⁱ/Tᵣₑₘₒₜₑ^{j} is an indication of how much power was consumed by remote computing resource of the CSP 104 on the data associated with element i divided by the amount of power consumed by remote computing resources on the data associated with element j. This list of tuples is generated by the remote telemetry circuitry 208 as a remote telemetry ratio vector TRᵣₑₘₒₜₑ.

Because vectors associated with TR_{local} represent power characteristics associated with the model of interest and the data set(s) of interest on local computing resources under the control of the end user, these power characteristic signatures are trusted by the end user. Additionally, even though remote computing resources under the control of the CSP 104 are different than the local computing resources of the end user, similar power consumption characteristic signatures are expected to occur. Stated differently, while similar power consumption characteristics may include different power consumption values for data associated with respective elements, the ratio values for pairs of data elements is expected to be similar (within an acceptable error margin range) when the CSP 104 performs inference using the correct (e.g., end user selected) model and the correct (e.g., end user selected) data.

The example target resource verification circuitry 106 determines a verification status of the CSP 104 in view of analysis of a number of pairs (D) of telemetry element values. In particular, the target resource verification circuitry 106 initializes a match counter (e.g., set to zero), and then begins to analyze pairs of telemetry element values (e.g., pairs of power values) corresponding to the CSP 104. For example, if element i and element j are a first selected one of the D pairs of samples, then the target resource verification circuitry 106 determines whether the pair ratio Tᵣₑₘₒₜₑⁱ/Tᵣₑₘₒₜₑ^{j} value is within an error factor & of the pair ratio T_{local}ⁱ/T_{local}^{j} of the end user platform computing resources. If not, then the match counter is not incremented. If so, then the match counter is incremented. In either circumstance, the target resource verification circuitry 106 determines if there are one or more pairs of telemetry element values of the CSP 104 to verify. If so, the next pair (e.g., elements k and l) are selected and compared against the corresponding ratio values of the local end user platform computing resources.

The example target resource verification circuitry 106 performs a verification of all paired elements in a manner consistent with example Equation 3.

$$Verification Status = ( \frac{Match Count}{D} ) * 100. \qquad Equation 3$$

In the illustrated example of Equation 3, if the verification status (match count divided by the total number of tested pairs of telemetry element values) is greater than a threshold value (t), then the CSP 104 is deemed to be operating in a manner consistent with the platform computing resources. Stated differently, the verification status indicates that the CSP 104 is operating in a manner compliant with the selected model and corresponding data. In such circumstances, the target resource verification circuitry 106 returns a “passing” indication, which authorizes payment distribution from the end user platform 102 to the CSP 104. On the other hand, in the event the verification status of example Equation 3 does not satisfy the threshold value (t), then the CSP 104 is deemed to be operating in an unauthorized manner and payment from the end user platform 102 to the CSP 104 is denied, withheld, unauthorized and/or otherwise prohibited.

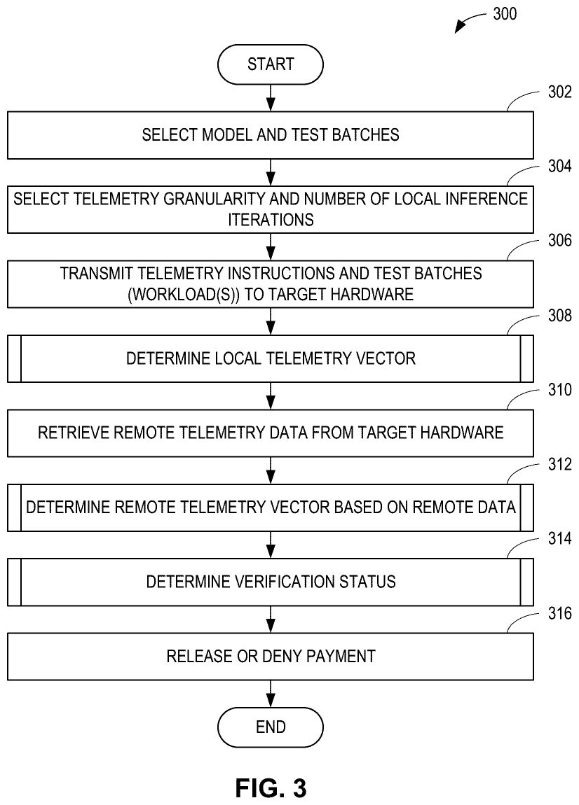

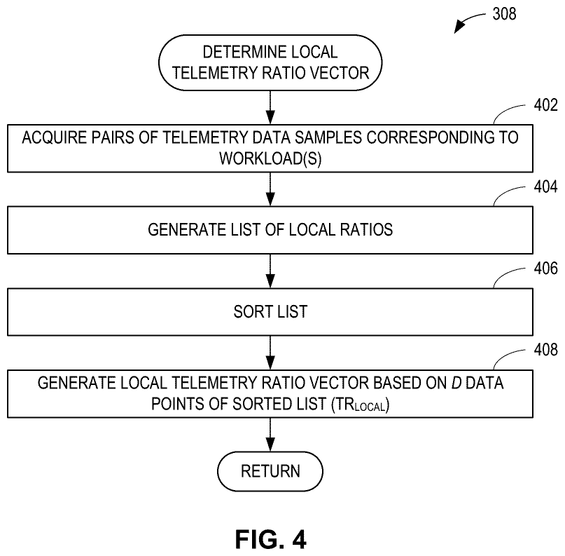

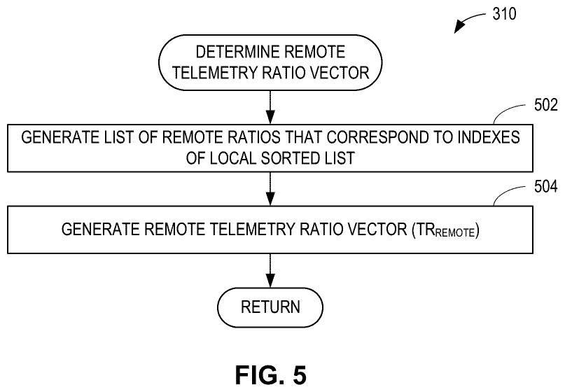

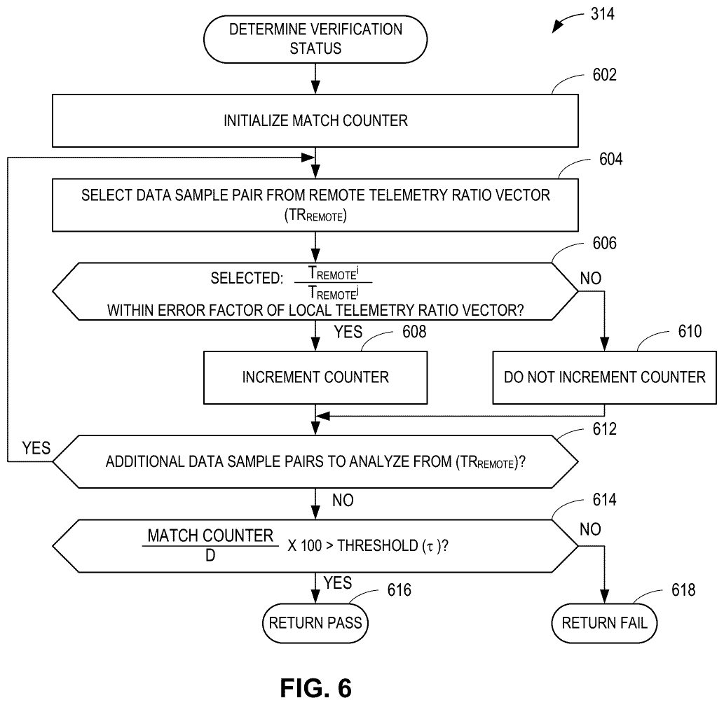

In some examples, the model/batch configuration circuitry 202 is instantiated by programmable circuitry executing configuration instructions and/or configured to perform operations such as those represented by the flowchart(s) of FIG. 3. In some examples, the target resource interface circuitry 204 is instantiated by programmable circuitry executing target resource interface instructions and/or configured to perform operations such as those represented by the flowchart(s) of FIGS. 3 and 6. In some examples, the local telemetry circuitry 206 is instantiated by programmable circuitry executing local telemetry instructions and/or configured to perform operations such as those represented by the flowchart(s) of FIGS. 3 and 4. In some examples, the remote telemetry circuitry 208 is instantiated by programmable circuitry executing remote telemetry instructions and/or configured to perform operations such as those represented by the flowchart(s) of FIGS. 3 and 5. In some examples, the target resource verification circuitry 106 is instantiated by programmable circuitry executing target resource verification instructions and/or configured to perform operations such as those represented by the flowcharts of FIGS. 3 and 6.

In some examples, the target resource verification circuitry 106 includes means for target resource verification. For example, the means for target resource verification may be implemented by target resource verification circuitry 106. In some examples, the target resource verification circuitry 106 includes means for model/batch configuration. For example, the means for model/batch configuration may be implemented by the model/batch configuration circuitry 202. In some examples, the target resource verification circuitry 106 includes means for target resource interfacing. For example, the means for target resource interfacing may be implemented by the target resource interface circuitry 204. In some examples, the target resource verification circuitry 106 includes means for local telemetry determination. For example, the means for local telemetry determination may be implemented by the local telemetry circuitry 206. In some examples, the target resource verification circuitry 106 includes means for remote telemetry determination. For example, the means for remote telemetry determination may be implemented by the remote telemetry circuitry 208.

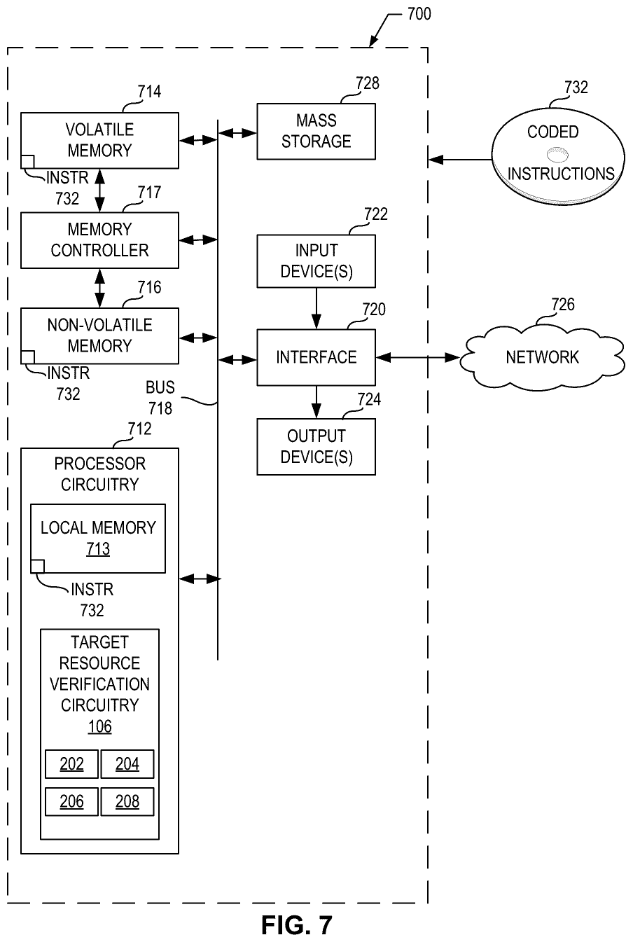

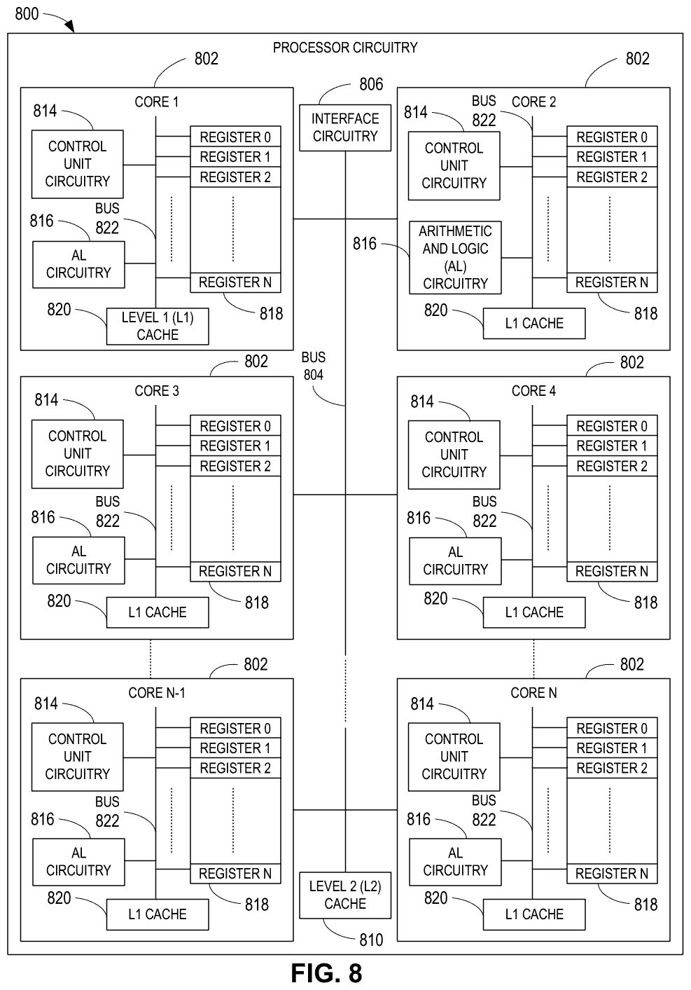

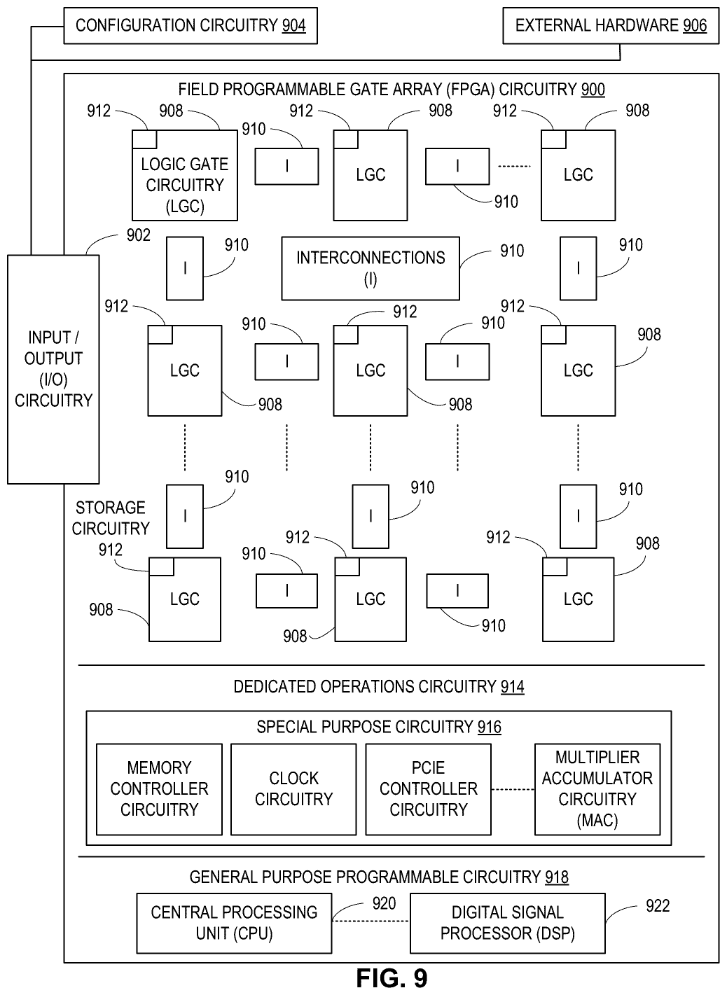

In some examples, the target resource verification circuitry 106, the model/batch configuration circuitry 202, the target resource interface circuitry 204, the local telemetry circuitry 206 and/or the remote telemetry circuitry 208 may be instantiated by programmable circuitry such as the example programmable circuitry 712 of FIG. 7. For instance, the aforementioned circuitry may be instantiated by the example microprocessor 800 of FIG. 8 executing machine executable instructions such as those implemented by at least FIGS. 3-6. In some examples, the aforementioned circuitry may be instantiated by hardware logic circuitry, which may be implemented by an ASIC, XPU, or the FPGA circuitry 900 of FIG. 9 configured and/or structured to perform operations corresponding to the machine-readable instructions. Additionally or alternatively, the aforementioned circuitry may be instantiated by any other combination of hardware, software, and/or firmware. For example, the aforementioned circuitry may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

While an example manner of implementing the target resource verification circuitry 106 of FIG. 1 is illustrated in FIG. 2, one or more of the elements, processes, and/or devices illustrated in FIG. 2 may be combined, divided, re-arranged, omitted, eliminated, and/or implemented in any other way. Further, the example model/batch configuration circuitry 202, the example target resource interface circuitry 204, the example local telemetry circuitry 206, the example remote telemetry circuitry 208, and/or, more generally, the example target resource verification circuitry 106 of FIG. 2, may be implemented by hardware alone or by hardware in combination with software and/or firmware. Thus, for example, any of the example model/batch configuration circuitry 202, the example target resource interface circuitry 204, the example local telemetry circuitry 206, the example remote telemetry circuitry 208, and/or, more generally, the example target resource verification circuitry 106 of FIG. 2, could be implemented by programmable circuitry in combination with machine-readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example target resource verification circuitry 106 of FIG. 2 may include one or more elements, processes, and/or devices in addition to, or instead of, those illustrated in FIG. 2, and/or may include more than one of any or all of the illustrated elements, processes and devices.

Flowchart(s) representative of example machine-readable instructions, which may be executed by programmable circuitry to implement and/or instantiate the target resource verification circuitry 106 of FIG. 2 and/or representative of example operations which may be performed by programmable circuitry to implement and/or instantiate the target resource verification circuitry 106 of FIG. 2, are shown in FIGS. 3-6. The machine-readable instructions may be one or more executable programs or portion(s) of one or more executable programs for execution by programmable circuitry such as the programmable circuitry 712 shown in the example processor platform 700 discussed below in connection with FIG. 7 and/or may be one or more function(s) or portion(s) of functions to be performed by the example programmable circuitry (e.g., an FPGA) discussed below in connection with FIGS. 8 and/or 9. In some examples, the machine-readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine-readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine-readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine-readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 3-6, many other methods of implementing the example target resource verification circuitry 106 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine-readable instructions described herein may be stored in one or more of a compressed format, an encrypted format, a fragmented format, a compiled format, an executable format, a packaged format, etc. Machine-readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine-readable instructions may be fragmented and stored on one or more storage devices, disks and/or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine-readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine-readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions and/or the corresponding program(s) can be executed in whole or in part. Thus, machine-readable, computer readable and/or machine-readable media, as used herein, may include instructions and/or program(s) regardless of the particular format or state of the machine-readable instructions and/or program(s).

The machine-readable instructions described herein can be represented by any past, present, or future instruction language, scripting language, programming language, etc. For example, the machine-readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 3-6 may be implemented using executable instructions (e.g., computer readable and/or machine-readable instructions) stored on one or more non-transitory computer readable and/or machine-readable media. As used herein, the terms non-transitory computer readable medium, non-transitory computer readable storage medium, non-transitory machine-readable medium, and/or non-transitory machine-readable storage medium are expressly defined to include any type of computer readable storage device and/or storage disk and to exclude propagating signals and to exclude transmission media. Examples of such non-transitory computer readable medium, non-transitory computer readable storage medium, non-transitory machine-readable medium, and/or non-transitory machine-readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine-readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine-readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine-readable instructions, etc., and/or manufactured to execute computer-readable instructions, machine-readable instructions, etc.

FIG. 3 is a flowchart representative of example machine-readable instructions and/or example operations 300 that may be executed, instantiated, and/or performed by programmable circuitry to verify the integrity of model execution on computing resources using telemetry information. The example machine-readable instructions and/or the example operations 300 of FIG. 3 begin at block 302, at which the example model/batch configuration circuitry 202 selects a target model to be used and target test batches (e.g., data and/or workloads to be executed by the selected model). The example model/batch configuration circuitry 202 selects a telemetry granularity and a number of inference iterations to be performed by the target CSP 104 (block 304). In particular, the CSP 104 performs inference remotely, and the end user platform 102 performs inference locally. Further, the CSP 104 performs inference tasks on all test batches, but the end user platform 102 performs inference tasks on a selected subset of the test batches. In this scenario, the granularity of telemetry recording(s) is/are the same for remote and local inference runs. The example target resource interface circuitry 204 transmits instructions (e.g., instructions to cause CSP 104 inference behaviors) and the test batches to the target hardware (e.g., the CSP 104) (block 306).

The local telemetry circuitry determines one or more local telemetry vectors (block 308), and the target resource interface circuitry 204 retrieves remote telemetry data from the target hardware (e.g., the CSP 104) (block 310). The example remote telemetry circuitry 208 determines one or more remote telemetry vectors based on the retrieved remote telemetry data (block 312), and the target resource verification circuitry 106 determines a verification status of the target hardware (e.g., the CSP 104) (block 314). Based on a threshold value, the target resource verification circuitry 106 either releases or denies payment to the CSP 104 (block 316).

FIG. 4 illustrates additional detail corresponding to determining one or more local telemetry vectors (block 308). In the illustrated example of FIG. 4, the local telemetry circuitry 308 acquires pairs of telemetry data samples corresponding to workload execution (block 402), and generates a list of local ratio values (block 404). The local telemetry circuitry 308 sorts the list (block 406), such as by relatively highest ratio values, and generates local telemetry ratio vectors based on a number of data points from the sorted list (block 408), which are referred to as TR_{local}. As described above, the local telemetry vectors represent expectation metrics (ratios) for any target hardware for comparison purposes. In the event the target hardware exhibits similar ratio metrics (e.g., within an acceptable error margin range), then that target hardware is deemed to be operating in a manner compliant with the selected model and workload data.

FIG. 5 illustrates additional detail corresponding to determining remote telemetry ratio vectors (block 310) of FIG. 3. In the illustrated example of FIG. 5, the remote telemetry circuitry 208 generates a list of remote ratio values that correspond to indexes of the local sorted list (block 502). The remote telemetry circuitry 208 generates remote telemetry ratio vectors (block 504), which are referred to as TRᵣₑₘₒₜₑ.

FIG. 6 illustrates additional detail corresponding to determining a verification status of the CSP 104 (block 314) of FIG. 3. In the illustrated example of FIG. 6, the target resource verification circuitry 106 initializes a match counter (block 602) and selects a data sample pair from the remote telemetry ratio vector (TRᵣₑₘₒₜₑ) (block 604). The target resource verification circuitry 106 determines if the ratio (ratio value) of the selected data sample pair is within an error factor (ε) of the corresponding ratio (ratio value) of the local data sample pair from the local telemetry ratio vector TR_{local} (block 606). If not, then the target resource verification circuitry 106 does not increment the match counter (block 610), otherwise the match counter is incremented (block 608).

In either circumstance, the target resource verification circuitry 106 determines whether there are one or more additional data sample pairs to analyze from the remote telemetry ratio vector (TRᵣₑₘₒₜₑ) (block 612). If so, control returns to block 604, in which another pair is selected for analysis. If not, the target resource verification circuitry 106 determines whether a threshold portion of the pairs of data samples satisfies (e.g., exceeds) a threshold (t) value (block 614). If so, then the CSP 104 is deemed to be valid and/or otherwise operating in an expected manner that complies with the selected model and data (workload data) (block 616). If not, then the CSP 104 is deemed to be invalid, and a failure indication is set (block 618).

FIG. 7 is a block diagram of an example programmable circuitry platform 700 structured to execute and/or instantiate the example machine-readable instructions and/or the example operations of FIGS. 3-6 to implement the target resource verification circuitry 106 of FIG. 2. The programmable circuitry platform 700 can be, for example, a server, a personal computer, a workstation, a self-learning machine (e.g., a neural network), a mobile device (e.g., a cell phone, a smart phone, a tablet such as an iPad™), an Internet appliance, a gaming console, a set top box, a headset (e.g., an augmented reality (AR) headset, a virtual reality (VR) headset, etc.) or other wearable device, or any other type of computing and/or electronic device.

The programmable circuitry platform 700 of the illustrated example includes programmable circuitry 712. The programmable circuitry 712 of the illustrated example is hardware. For example, the programmable circuitry 712 can be implemented by one or more integrated circuits, logic circuits, FPGAs, microprocessors, CPUs, GPUs, DSPs, and/or microcontrollers from any desired family or manufacturer. The programmable circuitry 712 may be implemented by one or more semiconductor based (e.g., silicon based) devices. In this example, the programmable circuitry 712 implements the example model/batch configuration circuitry 202, the example target resource interface circuitry 204, the example local telemetry circuitry 206, the example remote telemetry circuitry 208, and the target resource verification circuitry 106.

The programmable circuitry 712 of the illustrated example includes a local memory 713 (e.g., a cache, registers, etc.). The programmable circuitry 712 of the illustrated example is in communication with main memory 714, 716, which includes a volatile memory 714 and a non-volatile memory 716, by a bus 718. The volatile memory 714 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 716 may be implemented by flash memory and/or any other desired type of memory device. Access to the main memory 714, 716 of the illustrated example is controlled by a memory controller 717. In some examples, the memory controller 717 may be implemented by one or more integrated circuits, logic circuits, microcontrollers from any desired family or manufacturer, or any other type of circuitry to manage the flow of data going to and from the main memory 714, 716.

The programmable circuitry platform 700 of the illustrated example also includes interface circuitry 720. The interface circuitry 720 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 722 are connected to the interface circuitry 720. The input device(s) 722 permit(s) a user (e.g., a human user, a machine user, etc.) to enter data and/or commands into the programmable circuitry 712. The input device(s) 722 can be implemented by, for example, an audio sensor, a microphone, a camera (still or video), a keyboard, a button, a mouse, a touchscreen, a trackpad, a trackball, an isopoint device, and/or a voice recognition system.

One or more output devices 724 are also connected to the interface circuitry 720 of the illustrated example. The output device(s) 724 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 720 of the illustrated example, thus, typically includes a graphics driver card, a graphics driver chip, and/or graphics processor circuitry such as a GPU.

The interface circuitry 720 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 726. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 700 of the illustrated example also includes one or more mass storage discs or devices 728 to store firmware, software, and/or data. Examples of such mass storage discs or devices 728 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine-readable instructions 732, which may be implemented by the machine-readable instructions of FIGS. 3-6, may be stored in the mass storage device 728, in the volatile memory 714, in the non-volatile memory 716, and/or on at least one non-transitory computer readable storage medium such as a CD or DVD which may be removable.

FIG. 8 is a block diagram of an example implementation of the programmable circuitry 712 of FIG. 7. In this example, the programmable circuitry 712 of FIG. 7 is implemented by a microprocessor 800. For example, the microprocessor 800 may be a general-purpose microprocessor (e.g., general-purpose microprocessor circuitry). The microprocessor 800 executes some or all of the machine-readable instructions of the flowcharts of FIGS. 3-6 to effectively instantiate the circuitry of FIG. 2 as logic circuits to perform operations corresponding to those machine-readable instructions. In some such examples, the circuitry of FIG. 2 is instantiated by the hardware circuits of the microprocessor 800 in combination with the machine-readable instructions. For example, the microprocessor 800 may be implemented by multi-core hardware circuitry such as a CPU, a DSP, a GPU, an XPU, etc. Although it may include any number of example cores 802 (e.g., 1 core), the microprocessor 800 of this example is a multi-core semiconductor device including N cores. The cores 802 of the microprocessor 800 may operate independently or may cooperate to execute machine-readable instructions. For example, machine code corresponding to a firmware program, an embedded software program, or a software program may be executed by one of the cores 802 or may be executed by multiple ones of the cores 802 at the same or different times. In some examples, the machine code corresponding to the firmware program, the embedded software program, or the software program is split into threads and executed in parallel by two or more of the cores 802. The software program may correspond to a portion or all of the machine-readable instructions and/or operations represented by the flowcharts of FIGS. 3-6.

The cores 802 may communicate by a first example bus 804. In some examples, the first bus 804 may be implemented by a communication bus to effectuate communication associated with one(s) of the cores 802. For example, the first bus 804 may be implemented by at least one of an Inter-Integrated Circuit (I2C) bus, a Serial Peripheral Interface (SPI) bus, a PCI bus, or a PCIe bus. Additionally or alternatively, the first bus 804 may be implemented by any other type of computing or electrical bus. The cores 802 may obtain data, instructions, and/or signals from one or more external devices by example interface circuitry 806. The cores 802 may output data, instructions, and/or signals to the one or more external devices by the interface circuitry 806. Although the cores 802 of this example include example local memory 820 (e.g., Level 1 (L1) cache that may be split into an L1 data cache and an L1 instruction cache), the microprocessor 800 also includes example shared memory 810 that may be shared by the cores (e.g., Level 2 (L2 cache)) for high-speed access to data and/or instructions. Data and/or instructions may be transferred (e.g., shared) by writing to and/or reading from the shared memory 810. The local memory 820 of each of the cores 802 and the shared memory 810 may be part of a hierarchy of storage devices including multiple levels of cache memory and the main memory (e.g., the main memory 714, 716 of FIG. 7). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 802 may be referred to as a CPU, DSP, GPU, etc., or any other type of hardware circuitry. Each core 802 includes control unit circuitry 814, arithmetic and logic (AL) circuitry (sometimes referred to as an ALU) 816, a plurality of registers 818, the local memory 820, and a second example bus 822. Other structures may be present. For example, each core 802 may include vector unit circuitry, single instruction multiple data (SIMD) unit circuitry, load/store unit (LSU) circuitry, branch/jump unit circuitry, floating-point unit (FPU) circuitry, etc. The control unit circuitry 814 includes semiconductor-based circuits structured to control (e.g., coordinate) data movement within the corresponding core 802. The AL circuitry 816 includes semiconductor-based circuits structured to perform one or more mathematic and/or logic operations on the data within the corresponding core 802. The AL circuitry 816 of some examples performs integer based operations. In other examples, the AL circuitry 816 also performs floating-point operations. In yet other examples, the AL circuitry 816 may include first AL circuitry that performs integer-based operations and second AL circuitry that performs floating-point operations. In some examples, the AL circuitry 816 may be referred to as an Arithmetic Logic Unit (ALU).

The registers 818 are semiconductor-based structures to store data and/or instructions such as results of one or more of the operations performed by the AL circuitry 816 of the corresponding core 802. For example, the registers 818 may include vector register(s), SIMD register(s), general-purpose register(s), flag register(s), segment register(s), machine-specific register(s), instruction pointer register(s), control register(s), debug register(s), memory management register(s), machine check register(s), etc. The registers 818 may be arranged in a bank as shown in FIG. 8. Alternatively, the registers 818 may be organized in any other arrangement, format, or structure, such as by being distributed throughout the core 802 to shorten access time. The second bus 822 may be implemented by at least one of an I2C bus, a SPI bus, a PCI bus, or a PCIe bus.

Each core 802 and/or, more generally, the microprocessor 800 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 800 is a semiconductor device fabricated to include many transistors interconnected to implement the structures described above in one or more integrated circuits (ICs) contained in one or more packages.

The microprocessor 800 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 800, in the same chip package as the microprocessor 800 and/or in one or more separate packages from the microprocessor 800.

FIG. 9 is a block diagram of another example implementation of the programmable circuitry 712 of FIG. 7. In this example, the programmable circuitry 712 is implemented by FPGA circuitry 900. For example, the FPGA circuitry 900 may be implemented by an FPGA. The FPGA circuitry 900 can be used, for example, to perform operations that could otherwise be performed by the example microprocessor 800 of FIG. 8 executing corresponding machine-readable instructions. However, once configured, the FPGA circuitry 900 instantiates the operations and/or functions corresponding to the machine-readable instructions in hardware and, thus, can often execute the operations/functions faster than they could be performed by a general-purpose microprocessor executing the corresponding software.

More specifically, in contrast to the microprocessor 800 of FIG. 8 described above (which is a general purpose device that may be programmed to execute some or all of the machine-readable instructions represented by the flowchart(s) of FIGS. 3-6 but whose interconnections and logic circuitry are fixed once fabricated), the FPGA circuitry 900 of the example of FIG. 9 includes interconnections and logic circuitry that may be configured, structured, programmed, and/or interconnected in different ways after fabrication to instantiate, for example, some or all of the operations/functions corresponding to the machine-readable instructions represented by the flowchart(s) of FIGS. 3-6. In particular, the FPGA circuitry 900 may be thought of as an array of logic gates, interconnections, and switches. The switches can be programmed to change how the logic gates are interconnected by the interconnections, effectively forming one or more dedicated logic circuits (unless and until the FPGA circuitry 900 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 3-6. As such, the FPGA circuitry 900 may be configured and/or structured to effectively instantiate some or all of the operations/functions corresponding to the machine-readable instructions of the flowchart(s) of FIGS. 3-6 as dedicated logic circuits to perform the operations/functions corresponding to those software instructions in a dedicated manner analogous to an ASIC. Therefore, the FPGA circuitry 900 may perform the operations/functions corresponding to the some or all of the machine-readable instructions of FIGS. 3-6 faster than the general-purpose microprocessor can execute the same.

In the example of FIG. 9, the FPGA circuitry 900 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 900 of FIG. 9 may access and/or load the binary file to cause the FPGA circuitry 900 of FIG. 9 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 900 of FIG. 9 to cause configuration and/or structuring of the FPGA circuitry 900 of FIG. 9, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 900 of FIG. 9 may access and/or load the binary file to cause the FPGA circuitry 900 of FIG. 9 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 900 of FIG. 9 to cause configuration and/or structuring of the FPGA circuitry 900 of FIG. 9, or portion(s) thereof.

The FPGA circuitry 900 of FIG. 9, includes example input/output (I/O) circuitry 902 to obtain and/or output data to/from example configuration circuitry 904 and/or external hardware 906. For example, the configuration circuitry 904 may be implemented by interface circuitry that may obtain a binary file, which may be implemented by a bit stream, data, and/or machine-readable instructions, to configure the FPGA circuitry 900, or portion(s) thereof. In some such examples, the configuration circuitry 904 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 906 may be implemented by external hardware circuitry. For example, the external hardware 906 may be implemented by the microprocessor 800 of FIG. 8.

The FPGA circuitry 900 also includes an array of example logic gate circuitry 908, a plurality of example configurable interconnections 910, and example storage circuitry 912. The logic gate circuitry 908 and the configurable interconnections 910 are configurable to instantiate one or more operations/functions that may correspond to at least some of the machine-readable instructions of FIGS. 3-6 and/or other desired operations. The logic gate circuitry 908 shown in FIG. 9 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 908 to enable configuration of the electrical structures and/or the logic gates to form circuits to perform desired operations/functions. The logic gate circuitry 908 may include other electrical structures such as look-up tables (LUTs), registers (e.g., flip-flops or latches), multiplexers, etc.

The configurable interconnections 910 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 908 to program desired logic circuits.

The storage circuitry 912 of the illustrated example is structured to store result(s) of the one or more of the operations performed by corresponding logic gates. The storage circuitry 912 may be implemented by registers or the like. In the illustrated example, the storage circuitry 912 is distributed amongst the logic gate circuitry 908 to facilitate access and increase execution speed.

The example FPGA circuitry 900 of FIG. 9 also includes example dedicated operations circuitry 914. In this example, the dedicated operations circuitry 914 includes special purpose circuitry 916 that may be invoked to implement commonly used functions to avoid the need to program those functions in the field. Examples of such special purpose circuitry 916 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 900 may also include example general purpose programmable circuitry 918 such as an example CPU 920 and/or an example DSP 922. Other general purpose programmable circuitry 918 may additionally or alternatively be present such as a GPU, an XPU, etc., that can be programmed to perform other operations.

Although FIGS. 8 and 9 illustrate two example implementations of the programmable circuitry 712 of FIG. 7, many other approaches are contemplated. For example, FPGA circuitry may include an on-board CPU, such as one or more of the example CPU 920 of FIG. 8. Therefore, the programmable circuitry 712 of FIG. 7 may additionally be implemented by combining at least the example microprocessor 800 of FIG. 8 and the example FPGA circuitry 900 of FIG. 9. In some such hybrid examples, one or more cores 802 of FIG. 8 may execute a first portion of the machine-readable instructions represented by the flowchart(s) of FIGS. 3-6 to perform first operation(s)/function(s), the FPGA circuitry 900 of FIG. 9 may be configured and/or structured to perform second operation(s)/function(s) corresponding to a second portion of the machine-readable instructions represented by the flowcharts of FIG. 3-6, and/or an ASIC may be configured and/or structured to perform third operation(s)/function(s) corresponding to a third portion of the machine-readable instructions represented by the flowcharts of FIGS. 3-6.

It should be understood that some or all of the circuitry of FIG. 2 may, thus, be instantiated at the same or different times. For example, same and/or different portion(s) of the microprocessor 800 of FIG. 8 may be programmed to execute portion(s) of machine-readable instructions at the same and/or different times. In some examples, same and/or different portion(s) of the FPGA circuitry 900 of FIG. 9 may be configured and/or structured to perform operations/functions corresponding to portion(s) of machine-readable instructions at the same and/or different times.

In some examples, some or all of the circuitry of FIG. 2 may be instantiated, for example, in one or more threads executing concurrently and/or in series. For example, the microprocessor 800 of FIG. 8 may execute machine-readable instructions in one or more threads executing concurrently and/or in series. In some examples, the FPGA circuitry 900 of FIG. 9 may be configured and/or structured to carry out operations/functions concurrently and/or in series. Moreover, in some examples, some or all of the circuitry of FIG. 2 may be implemented within one or more virtual machines and/or containers executing on the microprocessor 800 of FIG. 8.

In some examples, the programmable circuitry 712 of FIG. 7 may be in one or more packages. For example, the microprocessor 800 of FIG. 8 and/or the FPGA circuitry 900 of FIG. 9 may be in one or more packages. In some examples, an XPU may be implemented by the programmable circuitry 712 of FIG. 7, which may be in one or more packages. For example, the XPU may include a CPU (e.g., the microprocessor 800 of FIG. 8, the CPU 920 of FIG. 9, etc.) in one package, a DSP (e.g., the DSP 922 of FIG. 9) in another package, a GPU in yet another package, and an FPGA (e.g., the FPGA circuitry 900 of FIG. 9) in still yet another package.

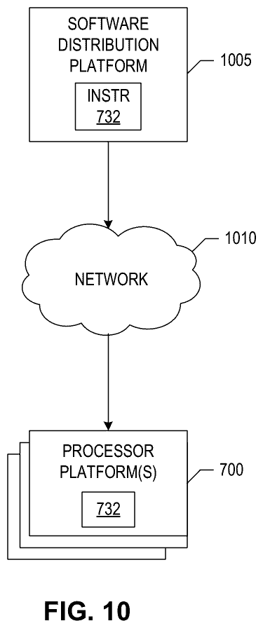

A block diagram illustrating an example software distribution platform 1005 to distribute software such as the example machine-readable instructions 732 of FIG. 7 to other hardware devices (e.g., hardware devices owned and/or operated by third parties from the owner and/or operator of the software distribution platform) is illustrated in FIG. 10. The example software distribution platform 1005 may be implemented by any computer server, data facility, cloud service, etc., capable of storing and transmitting software to other computing devices. The third parties may be customers of the entity owning and/or operating the software distribution platform 1005. For example, the entity that owns and/or operates the software distribution platform 1005 may be a developer, a seller, and/or a licensor of software such as the example machine-readable instructions 732 of FIG. 7. The third parties may be consumers, users, retailers, OEMs, etc., who purchase and/or license the software for use and/or re-sale and/or sub-licensing. In the illustrated example, the software distribution platform 1005 includes one or more servers and one or more storage devices. The storage devices store the machine-readable instructions 732, which may correspond to the example machine-readable instructions of FIGS. 3-6, as described above. The one or more servers of the example software distribution platform 1005 are in communication with an example network 1010, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine-readable instructions 732 from the software distribution platform 1005. For example, the software, which may correspond to the example machine-readable instructions of FIG. 3-6, may be downloaded to the example programmable circuitry platform 700, which is to execute the machine-readable instructions 732 to implement the target resource verification circuitry 106. In some examples, one or more servers of the software distribution platform 1005 periodically offer, transmit, and/or force updates to the software (e.g., the example machine-readable instructions 732 of FIG. 7) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time+/−1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that verify third party computing resources perform computing and/or other workload tasks in a manner as instructed and/or guided by a requestor. In some examples disclosed herein, requestors having particular workloads receive verification that the third party computing resources operate on such workloads using specifically designated models. Such verification addresses concerns that some third party computing resources (e.g., CSPs) may attempt to conserve their computing burdens and/or obligations by replacing designated models with relatively more simplistic models. Examples disclosed herein also permit the third party computing resources an opportunity to prove and/or otherwise verify that they comply with workload requests so that expected payment for their computing services occurs without doubt or suspicion of wrongdoing.

Example methods, apparatus, systems, and articles of manufacture to verify integrity of model execution on computing resources using telemetry information are disclosed herein. Further examples and combinations thereof include the following:

Example 1 includes an apparatus comprising machine-readable instructions, and at least one processor circuit to be programmed by the machine-readable instructions to instruct one or more first computing resources of a service provider to process a first model, compare first telemetry performance metrics received from the service provider with second telemetry performance metrics associated with baseline computing resources, and verify an integrity score of the service provider based on a similarity metric associated with the first telemetry performance metrics and the second telemetry performance metrics.

Example 2 includes the apparatus as defined in example 1, wherein one or more of the at least one processor circuit is to generate granularity parameters of the instructions to the one or more first computing resources, the granularity parameters to cause the first computing resources to process a quantity of input data with the first model to generate the first telemetry performance metrics.

Example 3 includes the apparatus as defined in example 2, wherein the quantity of input data includes a number of batches of the input data.

Example 4 includes the apparatus as defined in example 2, wherein the granularity parameters include layer assignment parameters to cause the first computing resources to calculate performance metrics associated with particular layers of the first model.

Example 5 includes the apparatus as defined in example 2, wherein one or more of the at least one processor circuit is to cause the first model to be processed with the baseline computing resources, the baseline computing resources to process a second quantity of the input data to generate the second telemetry performance metrics.

Example 6 includes the apparatus as defined in example 5, wherein one or more of the at least one processor circuit is to determine a ratio based on (a) an energy metric corresponding to the first quantity of the input data processed by the baseline computing resources and (b) an energy metric corresponding to the second quantity of the input data processed by the one or more first computing resources.

Example 7 includes the apparatus as defined in example 1, wherein the first telemetry performance metrics and the second telemetry performance metrics include at least one of power consumption values, temperature values, or computing cycles per unit of time values.

Example 8 includes the apparatus as defined in example 1, wherein one or more of the at least one processor circuit is to at least one of transmit payment authorization or refrain payment authorization to the service provider based on the integrity score.

Example 9 includes the apparatus as defined in example 1, wherein one or more of the at least one processor circuit is to select a first input data sample and a second input data sample to be processed by the baseline computing resources, the first and second input data samples to generate first and second energy metrics, generate the second telemetry performance metrics based on a first ratio of the first and second energy metrics, select the first input data sample and the second input data sample to be processed by the one or more first computing resources, the first and second input data samples to generate third and fourth energy metrics, and generate the first telemetry performance metrics based on a second ratio of the third and fourth energy metrics.

Example 10 includes the apparatus as defined in example 9, wherein one or more of the at least one processor circuit is to determine values of the first ratio and the second ratio are within the similarity metric.

Example 11 includes At least one non-transitory machine-readable medium comprising machine-readable instructions to cause at least one processor circuit to at least instruct one or more first computing resources of a service provider to process a first model, compare first telemetry performance metrics received from the service provider with second telemetry performance metrics associated with baseline computing resources, and verify an integrity score of the service provider based on a similarity metric associated with the first telemetry performance metrics and the second telemetry performance metrics.

Example 12 includes the at least one non-transitory machine-readable medium as defined in example 11, wherein the machine-readable instructions are to cause one or more of the at least one processor circuit to generate granularity parameters of the instructions to the one or more first computing resources, the granularity parameters to cause the first computing resources to process a quantity of input data with the first model to generate the first telemetry performance metrics.

Example 13 includes the at least one non-transitory machine-readable medium as defined in example 12, wherein the machine-readable instructions are to cause one or more of the at least one processor circuit to identify the quantity of input data includes a number of batches of the input data.

Example 14 includes the at least one non-transitory machine-readable medium as defined in example 12, wherein the machine-readable instructions are to cause one or more of the at least one processor circuit to identify the granularity parameters include layer assignment parameters to cause the first computing resources to calculate performance metrics associated with particular layers of the first model.

Example 15 includes the at least one non-transitory machine-readable medium as defined in example 12, wherein the machine-readable instructions are to cause one or more of the at least one processor circuit to cause the first model to be processed with the baseline computing resources, the baseline computing resources to process a second quantity of the input data to generate the second telemetry performance metrics.

Example 16 includes the at least one non-transitory machine-readable medium as defined in example 15, wherein the machine-readable instructions are to cause one or more of the at least one processor circuit to determine a ratio based on (a) an energy metric corresponding to the first quantity of the input data processed by the baseline computing resources and (b) an energy metric corresponding to the second quantity of the input data processed by the one or more first computing resources.

Example 17 includes the at least one non-transitory machine-readable medium as defined in example 11, wherein the machine-readable instructions are to cause one or more of the at least one processor circuit to identify the first telemetry performance metrics and the second telemetry performance metrics include at least one of power consumption values, temperature values, or computing cycles per unit of time values.

Example 18 includes the at least one non-transitory machine-readable medium as defined in example 11, wherein the machine-readable instructions are to cause one or more of the at least one processor circuit to at least one of transmit payment authorization or refrain payment authorization to the service provider based on the integrity score.

Example 19 includes the at least one non-transitory machine-readable medium as defined in example 11, wherein the machine-readable instructions are to cause one or more of the at least one processor circuit to select a first input data sample and a second input data sample to be processed by the baseline computing resources, the first and second input data samples to generate first and second energy metrics, generate the second telemetry performance metrics based on a first ratio of the first and second energy metrics, select the first input data sample and the second input data sample to be processed by the one or more first computing resources, the first and second input data samples to generate third and fourth energy metrics, and generate the first telemetry performance metrics based on a second ratio of the third and fourth energy metrics.

Example 20 includes the at least one non-transitory machine-readable medium as defined in example 19, wherein the machine-readable instructions are to cause one or more of the at least one processor circuit to determine values of the first ratio and the second ratio are within the similarity metric.

Example 21 includes a method comprising instructing one or more first computing resources of a service provider to process a first model, comparing first telemetry performance metrics received from the service provider with second telemetry performance metrics associated with baseline computing resources, and verifying an integrity score of the service provider based on a similarity metric associated with the first telemetry performance metrics and the second telemetry performance metrics.

Example 22 includes the method as defined in example 21, further including generating granularity parameters of the instructions to the one or more first computing resources, the granularity parameters to cause the first computing resources to process a quantity of input data with the first model to generate the first telemetry performance metrics.

Example 23 includes the method as defined in example 22, further including identifying the quantity of input data includes a number of batches of the input data.

Example 24 includes the method as defined in example 22, further including identifying the granularity parameters include layer assignment parameters to cause the first computing resources to calculate performance metrics associated with particular layers of the first model.

Example 25 includes the method as defined in example 22, further including causing the first model to be processed with the baseline computing resources, the baseline computing resources to process a second quantity of the input data to generate the second telemetry performance metrics.

Example 26 includes the method as defined in example 25, further including determining a ratio based on (a) an energy metric corresponding to the first quantity of the input data processed by the baseline computing resources and (b) an energy metric corresponding to the second quantity of the input data processed by the one or more first computing resources.

Example 27 includes the method as defined in example 21, further including identifying the first telemetry performance metrics and the second telemetry performance metrics include at least one of power consumption values, temperature values, or computing cycles per unit of time values.

Example 28 includes the method as defined in example 21, further including at least one of transmitting payment authorization or refraining payment authorization to the service provider based on the integrity score.

Example 29 includes the method as defined in example 21, further including selecting a first input data sample and a second input data sample to be processed by the baseline computing resources, the first and second input data samples to generate first and second energy metrics, generating the second telemetry performance metrics based on a first ratio of the first and second energy metrics, selecting the first input data sample and the second input data sample to be processed by the one or more first computing resources, the first and second input data samples to generate third and fourth energy metrics, and generating the first telemetry performance metrics based on a second ratio of the third and fourth energy metrics.

Example 30 includes the method as defined in example 29, further including determining values of the first ratio and the second ratio are within the similarity metric.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus comprising:
machine-readable instructions; and
at least one processor circuit to be programmed by the machine-readable instructions to:
instruct one or more first computing resources of a service provider to process a first model;
compare first telemetry performance metrics received from the service provider with second telemetry performance metrics associated with baseline computing resources; and
verify an integrity score of the service provider based on a similarity metric associated with the first telemetry performance metrics and the second telemetry performance metrics.

2. The apparatus as defined in claim 1, wherein one or more of the at least one processor circuit is to generate granularity parameters of the instructions to the one or more first computing resources, the granularity parameters to cause the first computing resources to process a quantity of input data with the first model to generate the first telemetry performance metrics.

3. The apparatus as defined in claim 2, wherein the quantity of input data includes a number of batches of the input data.

4. The apparatus as defined in claim 2, wherein the granularity parameters include layer assignment parameters to cause the first computing resources to calculate performance metrics associated with particular layers of the first model.

5. The apparatus as defined in claim 2, wherein one or more of the at least one processor circuit is to cause the first model to be processed with the baseline computing resources, the baseline computing resources to process a second quantity of the input data to generate the second telemetry performance metrics.

6. The apparatus as defined in claim 5, wherein one or more of the at least one processor circuit is to determine a ratio based on (a) an energy metric corresponding to the first quantity of the input data processed by the baseline computing resources and (b) an energy metric corresponding to the second quantity of the input data processed by the one or more first computing resources.

7. The apparatus as defined in claim 1, wherein the first telemetry performance metrics and the second telemetry performance metrics include at least one of power consumption values, temperature values, or computing cycles per unit of time values.

8. The apparatus as defined in claim 1, wherein one or more of the at least one processor circuit is to at least one of transmit payment authorization or refrain payment authorization to the service provider based on the integrity score.

9. The apparatus as defined in claim 1, wherein one or more of the at least one processor circuit is to:
select a first input data sample and a second input data sample to be processed by the baseline computing resources, the first and second input data samples to generate first and second energy metrics;
generate the second telemetry performance metrics based on a first ratio of the first and second energy metrics;
select the first input data sample and the second input data sample to be processed by the one or more first computing resources, the first and second input data samples to generate third and fourth energy metrics; and
generate the first telemetry performance metrics based on a second ratio of the third and fourth energy metrics.

10. The apparatus as defined in claim 9, wherein one or more of the at least one processor circuit is to determine values of the first ratio and the second ratio are within the similarity metric.

11. At least one non-transitory machine-readable medium comprising machine-readable instructions to cause at least one processor circuit to at least:
instruct one or more first computing resources of a service provider to process a first model;
compare first telemetry performance metrics received from the service provider with second telemetry performance metrics associated with baseline computing resources; and
verify an integrity score of the service provider based on a similarity metric associated with the first telemetry performance metrics and the second telemetry performance metrics.

12. The at least one non-transitory machine-readable medium as defined in claim 11, wherein the machine-readable instructions are to cause one or more of the at least one processor circuit to generate granularity parameters of the instructions to the one or more first computing resources, the granularity parameters to cause the first computing resources to process a quantity of input data with the first model to generate the first telemetry performance metrics.

13. The at least one non-transitory machine-readable medium as defined in claim 12, wherein the machine-readable instructions are to cause one or more of the at least one processor circuit to identify the quantity of input data includes a number of batches of the input data.

14. The at least one non-transitory machine-readable medium as defined in claim 12, wherein the machine-readable instructions are to cause one or more of the at least one processor circuit to identify the granularity parameters include layer assignment parameters to cause the first computing resources to calculate performance metrics associated with particular layers of the first model.

15. The at least one non-transitory machine-readable medium as defined in claim 12, wherein the machine-readable instructions are to cause one or more of the at least one processor circuit to cause the first model to be processed with the baseline computing resources, the baseline computing resources to process a second quantity of the input data to generate the second telemetry performance metrics.

16. The at least one non-transitory machine-readable medium as defined in claim 15, wherein the machine-readable instructions are to cause one or more of the at least one processor circuit to determine a ratio based on (a) an energy metric corresponding to the first quantity of the input data processed by the baseline computing resources and (b) an energy metric corresponding to the second quantity of the input data processed by the one or more first computing resources.

17. The at least one non-transitory machine-readable medium as defined in claim 11, wherein the machine-readable instructions are to cause one or more of the at least one processor circuit to identify the first telemetry performance metrics and the second telemetry performance metrics include at least one of power consumption values, temperature values, or computing cycles per unit of time values.

18. The at least one non-transitory machine-readable medium as defined in claim 11, wherein the machine-readable instructions are to cause one or more of the at least one processor circuit to at least one of transmit payment authorization or refrain payment authorization to the service provider based on the integrity score.

19. The at least one non-transitory machine-readable medium as defined in claim 11, wherein the machine-readable instructions are to cause one or more of the at least one processor circuit to:
select a first input data sample and a second input data sample to be processed by the baseline computing resources, the first and second input data samples to generate first and second energy metrics;
generate the second telemetry performance metrics based on a first ratio of the first and second energy metrics;
select the first input data sample and the second input data sample to be processed by the one or more first computing resources, the first and second input data samples to generate third and fourth energy metrics; and
generate the first telemetry performance metrics based on a second ratio of the third and fourth energy metrics.

20. The at least one non-transitory machine-readable medium as defined in claim 19, wherein the machine-readable instructions are to cause one or more of the at least one processor circuit to determine values of the first ratio and the second ratio are within the similarity metric.

21. A method comprising:
instructing one or more first computing resources of a service provider to process a first model;
comparing first telemetry performance metrics received from the service provider with second telemetry performance metrics associated with baseline computing resources; and
verifying an integrity score of the service provider based on a similarity metric associated with the first telemetry performance metrics and the second telemetry performance metrics.

22. The method as defined in claim 21, further including generating granularity parameters of the instructions to the one or more first computing resources, the granularity parameters to cause the first computing resources to process a quantity of input data with the first model to generate the first telemetry performance metrics.

23. The method as defined in claim 22, further including identifying the quantity of input data includes a number of batches of the input data.

24. The method as defined in claim 22, further including identifying the granularity parameters include layer assignment parameters to cause the first computing resources to calculate performance metrics associated with particular layers of the first model.

25. The method as defined in claim 22, further including causing the first model to be processed with the baseline computing resources, the baseline computing resources to process a second quantity of the input data to generate the second telemetry performance metrics.

26. The method as defined in claim 25, further including determining a ratio based on (a) an energy metric corresponding to the first quantity of the input data processed by the baseline computing resources and (b) an energy metric corresponding to the second quantity of the input data processed by the one or more first computing resources.

27. The method as defined in claim 21, further including identifying the first telemetry performance metrics and the second telemetry performance metrics include at least one of power consumption values, temperature values, or computing cycles per unit of time values.

28. The method as defined in claim 21, further including at least one of transmitting payment authorization or refraining payment authorization to the service provider based on the integrity score.

29. The method as defined in claim 21, further including:
selecting a first input data sample and a second input data sample to be processed by the baseline computing resources, the first and second input data samples to generate first and second energy metrics;
generating the second telemetry performance metrics based on a first ratio of the first and second energy metrics;
selecting the first input data sample and the second input data sample to be processed by the one or more first computing resources, the first and second input data samples to generate third and fourth energy metrics; and
generating the first telemetry performance metrics based on a second ratio of the third and fourth energy metrics.

30. The method as defined in claim 29, further including determining values of the first ratio and the second ratio are within the similarity metric.
